(19) United States
(12) Patent Application Publication
(10) Pub. No.: US 2025/0170598 A1
(43) Pub. Date: May 29, 2025

(54) ATOMIZATION DEVICE

(71) Applicant: PEGATRON CORPORATION, TAIPEI CITY (TW)

(72) Inventors: Chen-Hao Liu, Taipei City (TW); Tai-Jung Huang, Taipei City (TW)

(73) Assignee: PEGATRON CORPORATION, TAIPEI CITY (TW)

(21) Appl. No.: 18/776,151

(22) Filed: Jul. 17, 2024

(30) Foreign Application Priority Data
Nov. 24, 2023 (CN) 202311583916.X

(51) Int. Cl. B05B 5/00; B05B 5/053

(52) U.S. Cl. CPC B05B 5/001; B05B 5/0536

(57) ABSTRACT

An atomization device includes a cooling chip, a discharge electrode, a heat sink, and a counter electrode. The discharge electrode includes a first side, a second side opposite to the first side, and a plurality of first tip portions located on the first side. The second side is connected to the cooling chip. The cooling chip is located between the heat sink and the discharge electrode. The counter electrode is spaced apart from the discharge electrode and includes multiple second tip portions. The second tip portions and the first tip portions are opposite to each other.

### CROSS-REFERENCE TO RELATED APPLICATION

This application claims the priority benefit of China application serial no. 202311583916.X, filed on Nov. 24, 2023. The entirety of the above-mentioned patent application is hereby incorporated by reference herein and made a part of this specification.

### BACKGROUND

### Technical Field

The disclosure relates to an atomization device.

### Description of Related Art

Electrostatic atomization is a technology that applies an appropriate electric field to a substance to be atomized to disperse the substance. How to improve the atomization effect is a topic that needs to be explored in the field.

### SUMMARY

The disclosure provides an atomization device, which has a good atomization effect.

According to an embodiment of the disclosure, an atomization device includes a cooling chip, a discharge electrode, a heat sink, and a counter electrode. The discharge electrode includes a first side, a second side opposite to the first side, and multiple first tip portions located on the first side. The second side is connected to a cooling chip. The cooling chip is located between the heat sink and the discharge electrode. The counter electrode is spaced apart from the discharge electrode and includes multiple second tip portions. The second tip portions and the first tip portions are opposite to each other.

In the atomization device according to the embodiment of the disclosure, the discharge electrode includes an annular body.

In the atomization device according to the embodiment of the disclosure, the first tip portions extend and protrude from a side of the annular body away from the cooling chip toward the counter electrode.

In the atomization device according to the embodiment of the disclosure, the counter electrode has a hole, the perforated hole has a first diameter, the annular body has a second diameter, and the first diameter is greater than the second diameter.

In the atomization device according to the embodiment of the disclosure, the first tip portions are integrated with the annular body.

In the atomization device according to the embodiment of the disclosure, the discharge electrode includes a rod-shaped body.

In the atomization device according to the embodiment of the disclosure, the first tip portions extend and protrude from an end of the rod-shaped body away from the cooling chip toward the counter electrode.

In the atomization device according to the embodiment of the disclosure, the first tip portions are integrated with the rod-shaped body.

In the atomization device according to the embodiment of the disclosure, the counter electrode includes a plate body, the plate body has a hole, and the second tip portions are arranged along an edge of the hole and extend and protrude toward the discharge electrode.

In the atomization device according to the embodiment of the disclosure, the atomization device further includes a base disposed on the heat sink is further included, and the counter electrode is connected to the base.

In the atomization device according to the embodiment of the disclosure, the base includes a side wall, the side wall surrounds the discharge electrode, the side wall has a top portion away from the heat sink, and the plate body is connected to the top portion.

In the atomization device according to the embodiment of the disclosure, a material of the base includes an insulating material.

In the atomization device according to the embodiment of the disclosure, the second tip portions are integrated with the plate body.

In the atomization device according to the embodiment of the disclosure, a number of the first tip portions is equal to a number of the second tip portions.

Based on the above, in the atomization device of the disclosure, the discharge electrode includes the first tip portions. The counter electrode includes the second tip portions. More water droplets may be collected through the first tip portions, so that the amount sprayed toward the second tip portions is increased, which can increase the amount of liquid atomization.

### BRIEF DESCRIPTION OF THE DRAWINGS

FIG. 1 is a three-dimensional schematic view of an atomization device according to an embodiment of the disclosure;

FIG. 2 is a cross-sectional schematic view of the atomization device of FIG. 1.

FIG. 3 is a partial perspective schematic view of the atomization device of FIG. 1.

FIG. 4 is a top schematic view of the atomization device of FIG. 1.

FIG. 5 is a partial perspective schematic view of an atomization device according to another embodiment of the disclosure.

FIG. 6 is a cross-sectional schematic view of the atomization device of FIG. 5.

FIG. 7 is a top schematic view of the atomization device of FIG. 5.

### DESCRIPTION OF THE EMBODIMENTS

Reference will now be made in detail to the exemplary embodiments of the disclosure, and examples of the exemplary embodiments are illustrated in the drawings. Wherever possible, the same reference numerals are used in the drawings and the description to refer to the same or similar parts.

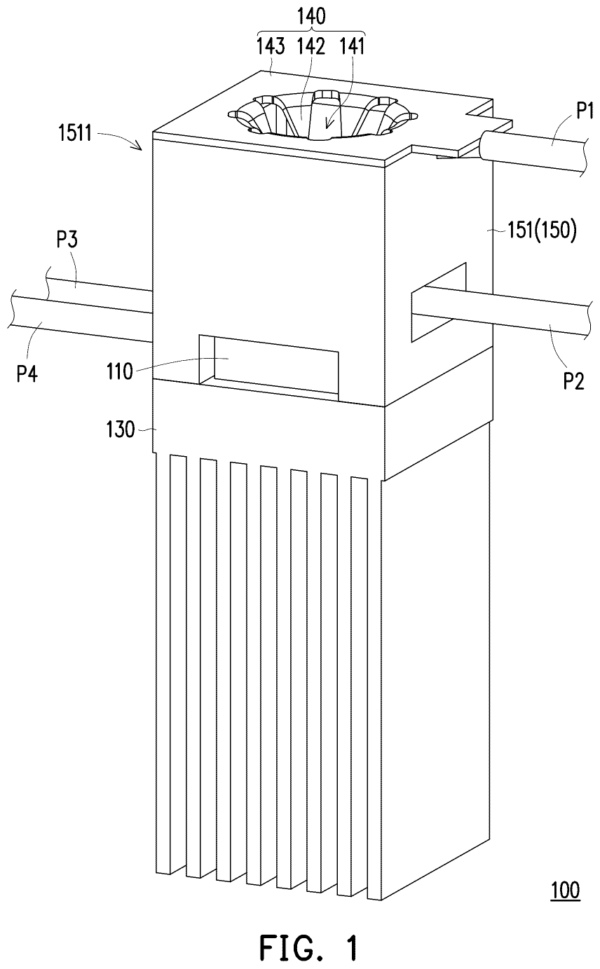

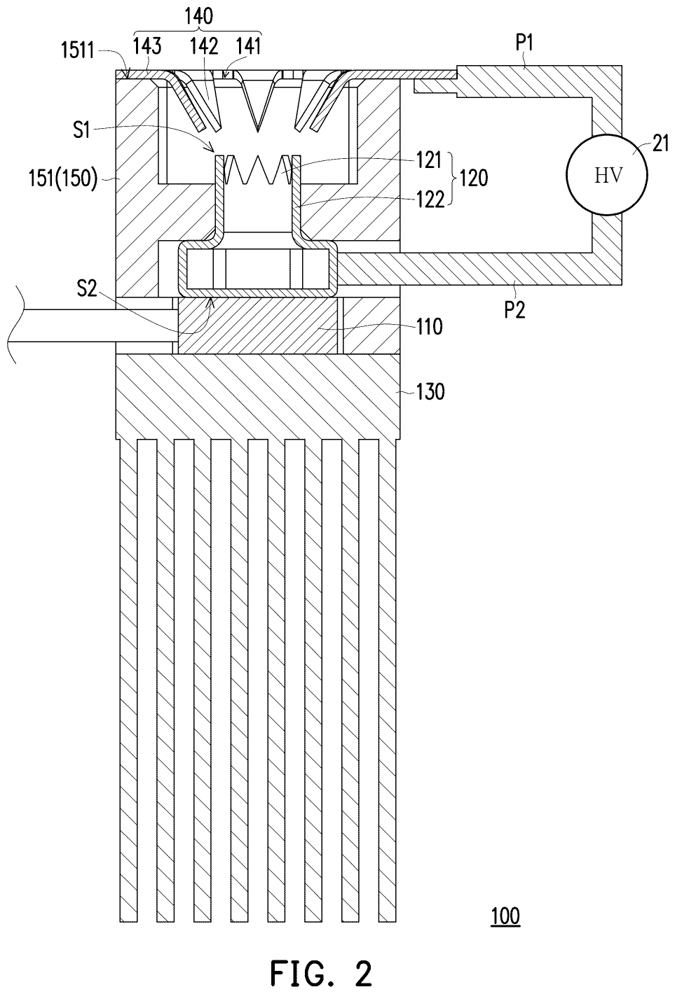

FIG. 1 is a three-dimensional schematic view of an atomization device according to an embodiment of the disclosure. FIG. 2 is a cross-sectional schematic view of the atomization device of FIG. 1. Please refer to FIG. 1 and FIG. 2. An atomization device 100 of the embodiment includes a cooling chip 110 (that is, a thermoelectric cooler, TEC), a discharge electrode 120, a heat sink 130, a counter electrode 140, and a base 150. The discharge electrode 120 includes a first side S1 and a second side S2 opposite to each other. The second side S2 of the discharge electrode 120 is connected to the cooling chip 110. The discharge electrode 120 includes multiple first tip portions 121 located on the first side S1. The counter electrode 140 includes multiple second tip portions 142.

In the embodiment, the counter electrode 140 and the discharge electrode 120 are spaced apart from each other, and the second tip portions 142 and the first tip portions 121 are opposite to each other. In other words, the counter electrode 140 and the discharge electrode 120 are spaced apart from and overlap with each other. A spacing distance between the counter electrode 140 and the discharge electrode 120 may be appropriately adjusted according to actual requirements. As long as the counter electrode 140 and the discharge electrode 120 are separated from each other and meet high voltage electrical safety considerations, the same falls within the protection scope of the disclosure.

In the embodiment, the counter electrode 140 is connected to the base 150. The material of the base 150 may include an insulating material. For example, the base 150 may be made of an insulating material. An inner space of the base 150 is configured to accommodate the discharge electrode 120, and the base 150 is disposed on the heat sink 130. Here, the heat sink 130 is, for example, a heat sink fin, but not limited thereto.

In the embodiment, the base 150 is configured to separate the discharge electrode 120 and the counter electrode 140. For example, the base 150 includes a side wall 151. The side wall 151 surrounds the discharge electrode 120, and the side wall 151 has a top portion 1511 away from the heat sink 130. The counter electrode 140 includes a plate body 143, and the plate body 143 is connected to the top portion 1511.

In the embodiment, the discharge electrode 120 includes an annular body 122. In other words, the discharge electrode 120 is in a crown shape. In other embodiments, the body of the discharge electrode 120 may also be in a square shape or a polygonal shape, but not limited thereto. The first tip portions 121 extend and protrude from a side of the annular body 122 away from the cooling chip 110 toward the counter electrode 140. The first tip portions 121 are integrated with the annular body 122.

In the embodiment, the cooling chip 110 is located between the heat sink 130 and the discharge electrode 120. Current is supplied to the cooling chip 110 through conductive lines P3 and P4, and the discharge electrode 120 is cooled through the cooling chip 110. Therefore, condensed water is generated on a surface of the discharge electrode 120, and more moisture present in the air in the base 150 may be collected through the first tip portions 121. In the embodiment, the cooling chip 110 for cooling the discharge electrode 120 is used as a water supply element for supplying water for atomization to the discharge electrode 120, but not limited thereto.

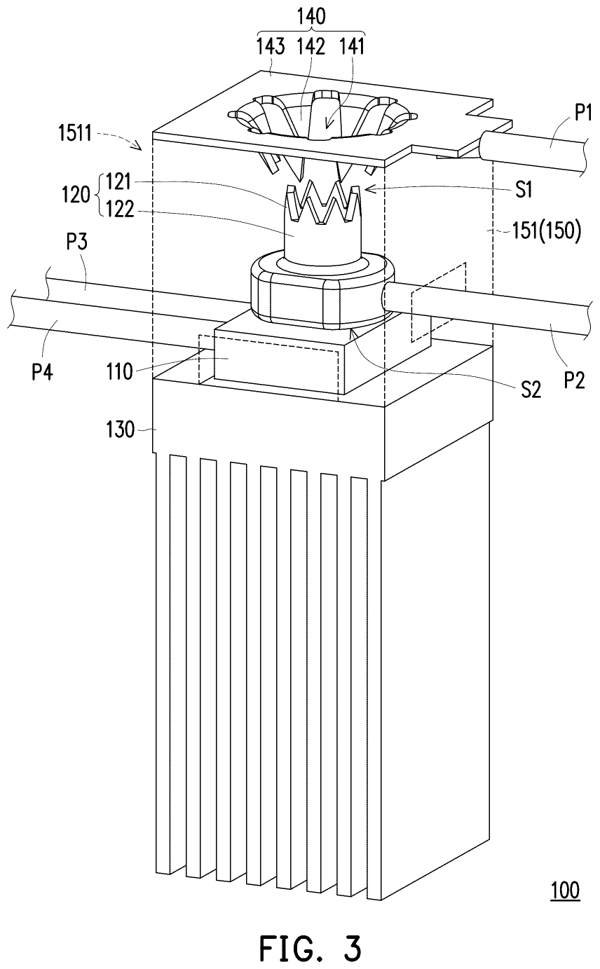

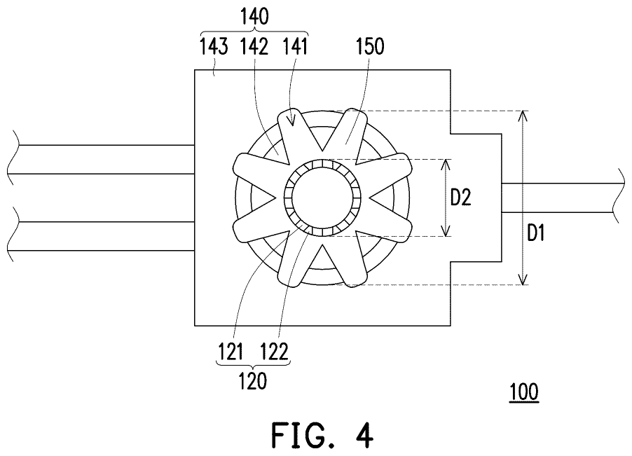

FIG. 4 is a top schematic view of the atomization device of FIG. 1. FIG. 3 is a partial perspective schematic view of the atomization device of FIG. 1. Please refer to FIG. 3 and FIG. 4. In the embodiment, the number of the first tip portions 121 is an even number (eight are schematically shown) and the first tip portions 121 are disposed opposite to each other in pairs, but not limited thereto. The number of the second tip portions 142 is an even number (eight are schematically shown) and the second tip portions 142 are disposed opposite to each other in pairs, but not limited thereto. Here, the number of the first tip portions 121 is equal to the number of the second tip portions 142, but not limited thereto.

In the embodiment, the counter electrode 140 has a hole 141 located on the plate body 143, and the second tip portions 142 are arranged along an edge of the hole 141 and extend and protrude toward the discharge electrode 120. The second tip portions 142 are integrated with the plate body 143.

In the embodiment, the hole 141 has a first diameter D1, the annular body 122 has a second diameter D2, and the first diameter D1 is greater than the second diameter D2. Water mist generated by the discharge electrode 120 flows to the outside of the base 150 through the hole 141.

For details, please refer to FIG. 2. In the embodiment, an end of the conductive line P2 is connected to the discharge electrode 120 in the base 150, and the other end of the conductive line P2 is connected to a voltage application unit 21 disposed outside the base 150. An end of the conductive line P1 is connected to the counter electrode 140 on the base 150, and the other end of the conductive line P1 is connected to the voltage application unit 21 disposed outside the base 150. The voltage application unit 21 applies a high voltage for electrostatic atomization between the discharge electrode 120 and the counter electrode 140.

In the embodiment, the first tip portions 121 provide the high voltage from the single voltage application unit 21. For example, the discharge electrode 120 holding water in the first tip portions 121 is adapted to be applied with the high voltage by the voltage application unit 21, so that charges may be concentrated on the first tip portions 121 of the discharge electrode 120 as a negative electrode, and the water held on the first tip portions 121 is repeatedly subjected to Rayleigh fission generated by a large amount of energy, which generates a large number of charged water particles. The charged water particles move toward the counter electrode 140 and then pass through the holes 141 of the counter electrode 140 to be discharged to the outside.

Under the above configuration, the first tip portions 121 may collect more water droplets, so that the amount sprayed toward the second tip portions 142 is increased, which can increase the amount of liquid atomization.

Other embodiments are listed below for illustration. It must be noted here that the following embodiment continues to use the reference numerals and some content of the previous embodiment, wherein the same numerals are adopted to represent the same or similar elements, and the description of the same technical content is omitted. For the description of the omitted part, reference may be made to the previous embodiment, which will not be repeated in the following embodiment.

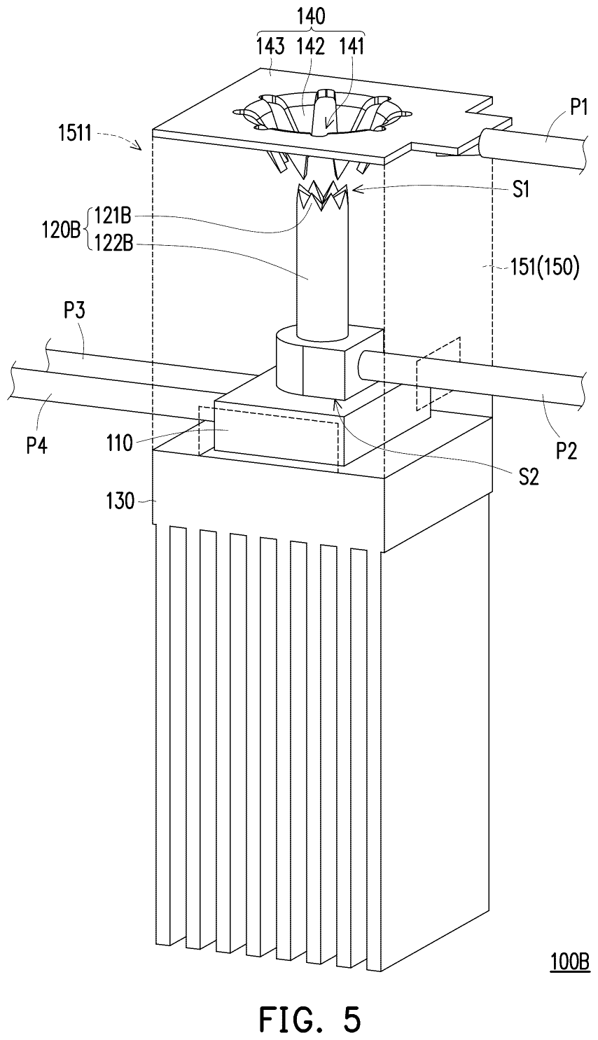

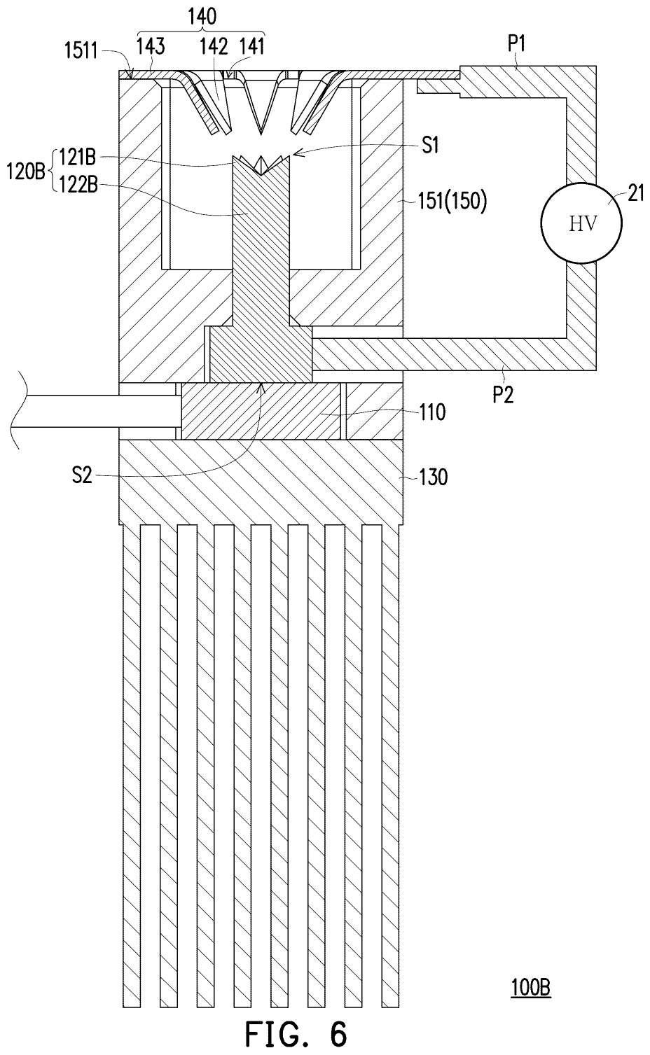

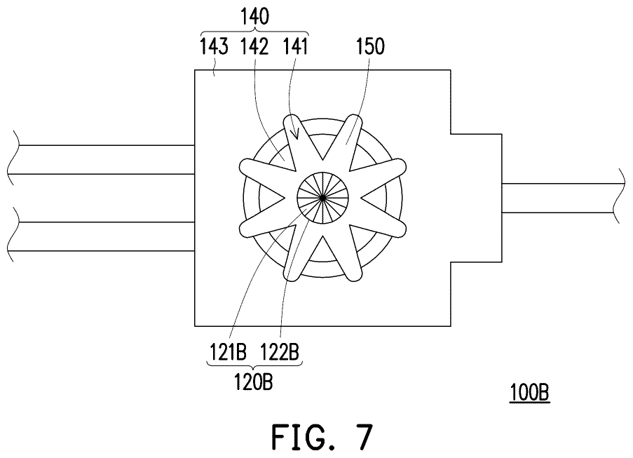

FIG. 5 is a partial perspective schematic view of an atomization device according to another embodiment of the disclosure. FIG. 6 is a cross-sectional schematic view of the atomization device of FIG. 5. FIG. 7 is a top schematic view of the atomization device of FIG. 5. Please refer to FIG. 5 to FIG. 7. In the embodiment, an atomization device 100B is slightly different from the atomization device 100 of FIG. 4. The main difference lies in the form of a discharge electrode 120B.

In the embodiment, the discharge electrode 120B includes a rod-shaped body 122B. The rod-shaped body 122B and the annular body 122 shown on FIGS. 2 and 3 both are cylindrical, but the height of the rod-shaped body 122B is greater than the height of the annular body 122. Multiple first tip portions 121B extend and protrude from an end of the rod-shaped body 122B away from the cooling chip 110 toward the counter electrode 140. The first tip portions 121B are integrated with the rod-shaped body 122B. Such a design can reduce the overall volume.

A high voltage for electrostatic atomization is applied between the discharge electrode 120B and the counter electrode 140 through the voltage application unit 21. The discharge electrode 120B holding water in the first tip portions 121B is adapted to be applied with the high voltage by the voltage application unit 21, so that charges may be concentrated on the first tip portions 121B of the discharge electrode 120B as a negative electrode, and the water held on the first tip portions 121B is repeatedly subjected to Rayleigh fission generated by a large amount of energy, which generates a large number of charged water particles. The charged water particles move toward the counter electrode 140 and then pass through the hole 141 of the counter electrode 140 to be discharged to the outside.

In this way, the first tip portions 121B may collect more water droplets, so that the amount sprayed toward the second tip portions 142 is increased, which can increase the amount of liquid atomization.

In summary, in the atomization device of the disclosure, the discharge electrode includes the first tip portions. The counter electrode includes the second tip portions. More water droplets may be collected through the first tip portions, so that the amount sprayed toward the second tip portions is increased, which can increase the amount of liquid atomization.

Finally, it should be noted that the above embodiments are only used to illustrate, but not to limit, the technical solutions of the disclosure. Although the disclosure has been described in detail with reference to the above embodiments, persons skilled in the art should understand that the technical solutions described in the above embodiments may still be modified or some or all of the technical features thereof may be equivalently replaced. However, the modifications or replacements do not cause the essence of the corresponding technical solutions to deviate from the scope of the technical solutions of the embodiments of the disclosure.

What is claimed is:

1. An atomization device, comprising:
a cooling chip;
a discharge electrode, comprising a first side and a second side opposite to each other and a plurality of first tip portions located on the first side, wherein the second side is connected to the cooling chip;
a heat sink, wherein the cooling chip is located between the heat sink and the discharge electrode; and
a counter electrode, spaced apart from the discharge electrode and comprising a plurality of second tip portions, wherein the second tip portions and the first tip portions are opposite to each other.

2. The atomization device according to claim 1, wherein the discharge electrode comprises an annular body.

3. The atomization device according to claim 2, wherein the first tip portions extend and protrude from a side of the annular body away from the cooling chip toward the counter electrode.

4. The atomization device according to claim 2, wherein the counter electrode comprises a hole, the hole comprises a first diameter, the annular body comprises a second diameter, and the first diameter is greater than the second diameter.

5. The atomization device according to claim 2, wherein the first tip portions are integrated with the annular body.

6. The atomization device according to claim 1, wherein the discharge electrode comprises a rod-shaped body.

7. The atomization device according to claim 6, wherein the first tip portions extend and protrude from an end of the rod-shaped body away from the cooling chip toward the counter electrode.

8. The atomization device according to claim 6, wherein the first tip portions are integrated with the rod-shaped body.

9. The atomization device according to claim 1, wherein the counter electrode comprises a plate body, the plate body comprises a hole, and the second tip portions are arranged along an edge of the hole and extend and protrude toward the discharge electrode.

10. The atomization device according to claim 9, further comprising a base disposed on the heat sink, wherein the counter electrode is connected to the base.

11. The atomization device according to claim 10, wherein the base comprises a side wall, the side wall surrounds the discharge electrode, the side wall has a top portion away from the heat sink, and the plate body is connected to the top portion.

12. The atomization device according to claim 10, wherein a material of the base comprises an insulating material.

13. The atomization device according to claim 9, wherein the second tip portions are integrated with the plate body.

14. The atomization device according to claim 1, wherein a number of the first tip portions is equal to a number of the second tip portions.

15. The atomization device according to claim 1, wherein a number of the first tip portions is an even number.
